(19) United States
(12) Patent Application Publication
(10) Pub. No.: US 2013/0093239 A1
(43) Pub. Date: Apr. 18, 2013

(54) VEHICLE STRUCTURE

(71) Applicant: Dr. Ing. h.c. F. Porsche Aktiengesellschaft, Stuttgart (DE)

(72) Inventor: Markus Brunner, Sachsenheim (DE)

(73) Assignee: DR. ING. H.C. F. PORSCHE AKTIENGESELLSCHAFT, Stuttgart (DE)

(21) Appl. No.: 13/648,285

(22) Filed: Oct. 10, 2012

(30) Foreign Application Priority Data
Oct. 12, 2011 (DE) 102011054432.1

(51) Int. Cl. B60L 1/00

(52) U.S. Cl. 307/10.1; 307/9.1

(57) ABSTRACT

A vehicle structure includes a composite supporting structure made of a substantially electrically non-conducting composite material and at least one ground connection line. The ground connection line is integrated into the composite supporting structure.

### CROSS REFERENCE TO RELATED APPLICATIONS

This application claims priority to German Patent Application No. DE 10 2011 054 432.1, filed Oct. 12, 2011, which is hereby incorporated by reference herein in its entirety.

### FIELD

The invention relates to a composite supporting structure made of an electrically non-conducting or non-sufficiently conducting composite material, comprising at least one ground connection line.

### BACKGROUND

German laid-open specification DE 10 2009 053 241 A1 describes a motor vehicle having a connection line and a safety conductor which is arranged along the connection line. The connection line runs at least partially within or along a passenger cabin of the motor vehicle. The safety conductor is designed at least partially as a conductor mesh, as a conductor fabric, as a conductor braid, as a conductor foil, as a conductor well or as a conductor tube which sheathes the connection line or runs along the connection line. A ground return conductor can be formed by the safety conductor or be electrically connected thereto.

### SUMMARY

In an embodiment, the present invention provides a vehicle structure including a composite supporting structure made of a substantially electrically non-conducting composite material and at least one ground connection line. The ground connection line is integrated into the composite supporting structure.

### BRIEF DESCRIPTION OF THE DRAWINGS

Exemplary embodiments of the present invention are described in more detail below with reference to the drawings. in which:

FIG. 1 shows a perspective illustration of a composite supporting structure according to an embodiment of the invention, with a. transparently illustrated composite material in order to make visible inserts and ground connection lines inserted into the composite material;

FIG. 2 shows a perspective illustration of a detail from FIG. 1 according to a further exemplary embodiment;

FIG. 3 shows a non-transparently illustrated composite supporting structure with a ground rail from inside;

FIG. 4 shows the same view as in FIG. 3, wherein the composite material is transparently illustrated;

FIG. 5 shows the composite supporting structure from FIGS. 3 and 4 from outside and non-transparently; and

FIG. 6 shows the composite supporting structure from FIGS. 3 to 5 from outside and transparently.

### DETAILED DESCRIPTION

In an embodiment, the present invention provides a simplified ground connection when using a composite supporting structure made of an electrically non-conducting or non-sufficiently conducting composite material, comprising at least one ground connection line.

In an embodiment, the present invention provides a composite supporting structure made of an electrically non-conducting or non-sufficiently conducting composite material, comprising at least one ground connection line, in that the ground connection line is integrated into the composite supporting structure. The composite supporting structure is preferably a fiber-reinforced plastic material. Here, fibers, for example glass fibers or carbon fibers, are embedded into the plastic material for reinforcement purposes. A plastic material reinforced with glass fibers is also referred to as GFP composite material. A plastic material reinforced with carbon fibers is also referred to as CFP composite material. Such composite supporting structures have the advantage that they are relatively light and yet have a very high strength, i.e. can be subjected to heavy loading. For this purpose, such composite supporting structures are being increasingly used in motor vehicles. A complete vehicle body consisting of such a composite supporting structure is also referred to as a monocoque. The composite supporting structure preferably comprises a plurality of layers comprising fiber layers which are laminated over one another. In conjunction with the present invention, the expression “integrated into the composite supporting structure” means that the ground connection line is arranged at least partially, but preferably completely, within the composite supporting structure. For this purpose, the ground connection line is inserted into the composite supporting structure during the production thereof.

A preferred exemplary embodiment of the composite supporting structure is characterized in that the ground connection line connects two inserts to one another in an electrically conducting manner, which inserts are integrated into the composite supporting structure. The term “inserts” refers to insert pieces or insert parts which are arranged at least partially within the composite supporting structure. The inserts are preferably not formed from the composite material, but from metal, for example. Here, the inserts are preferably arranged in corner regions and/or functional regions in the composite supporting structure.

A further preferred exemplary embodiment of the composite supporting structure includes a plurality of ground connection lines of a ground connection line system that are integrated into the composite supporting structure, wherein the around connection lines of the ground connection system in each case connect two inserts to one another in an electrically conducting manner, which inserts are integrated into the composite supporting structure. The inserts are inserted, preferably together with the ground connection lines, during the production of the composite supporting structure and enclosed, at least partially, by the composite material.

In a further preferred exemplary embodiment of the composite supporting structure a ground connection line or around connection lines is or are formed from an electrically conductive fabric and/or braid, in particular from an aluminum fabric and/or aluminum braid. The electrically conductive fabric and/or braid can be inserted in a simple manner during the production of the composite supporting structure. The form and the dimensions of the electrically conductive fabric and/or braid are selected such that a sufficient ground conduction is provided between two inserts. If appropriate, it is also possible for a plurality of electrically conductive fabrics and/or braids to be combined to constitute a ground connection line.

A further preferred exemplary embodiment of the composite supporting structure includes inserts that are formed from an electrically conductive material, in particular from an aluminum material. As a result, the ground connection lines can be connected to one another simply in an electrically conducting manner. The inserts and the ground connection lines are preferably formed from the same material.

A further preferred exemplary embodiment of the composite supporting structure includes inserts that are inserted or embedded into the composite supporting structure with the ground connection line or the ground connection lines. During the production of the composite supporting structure, the inserts are inserted, preferably together with the ground connection line or the ground connection lines, into a mold and enclosed by a plastic matrix into which fibers are embedded for reinforcement purposes.

In a further preferred exemplary embodiment of the composite supporting structure, for assembly or manufacturing purposes, in particular for inserting or embedding into the composite supporting structure, the inserts are connected to the ground connection line or the ground connection lines. The connection between a ground connection line and an insert can be produced, for example, by foaming Here, for example, a cavity of an insert into which at least one end of a ground connection line projects is foamed with a plastic foam in order to fix the end of the ground connection line relative to the insert.

In a further preferred exemplary embodiment of the composite supporting structure is characterized in that the inserts and/or the ground connection line or ground connection lines are enclosed by at least one fiber layer of an electrically insulating fiber material of the composite supporting structure. For insulation, the inserts or the ground connection line or ground connection lines can be sheathed, for example, with at least one glass fiber layer.

A further preferred exemplary embodiment of the composite supporting structure includes inserts and/or a ground rail that are connected to the ground connection line or the ground connection lines by means of fastening elements made of an electrically conductive material. For example, the inserts and/or the ground rail can be connected to the ground connection line or the ground connection lines by means of screwing or riveting such that in each case at least one screw or one rivet extends through an insert or a ground rail and through a ground connection line. As a result, an electrically conducting connection is thereby provided in a simple manner between the parts traversed by the respective fastening element.

The invention further relates to an insert and/or a ground connection line for an above-described composite supporting structure, and/or to a motor vehicle having an above-described composite supporting structure. The composite supporting structure according to the invention is used in particular in sports cars, in particular in supersports cars. The composite supporting structure according to the invention simplifies the ground conduction for electrical devices in such a motor vehicle. Production costs can be saved as a result of the functional integration of the ground connection line into the composite material. Moreover, the weight of the motor vehicle can be reduced by comparison with the use of conventional ground cables.

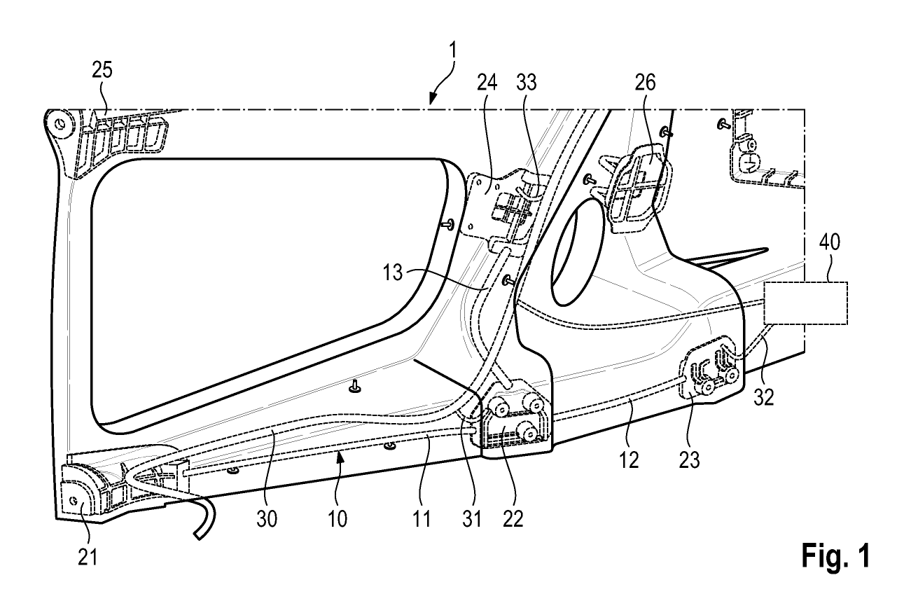

FIGS. 1 to 6 depict a composite supporting structure 1 in various views and according to various exemplary embodiments. The composite supporting structure 1 is a part of a self-supporting body of a motor vehicle. The composite supporting structure 1 is formed from a composite material having a plastic matrix into which fibers, in particular carbon fibers, are embedded for reinforcing purposes.

According to an aspect of the invention, a ground connection line system 10 having ground connection lines 11, 12, 13 is integrated into the composite material of the composite supporting structure I. The ground connection lines 11 to 13 are formed from an aluminum fabric or aluminum braid and electrically insulated by sheathing with at least one glass fiber layer.

The ground connection lines 11, 12 13 in each case connect two inserts 21, 22; 22, 23; 22, 24 to one another. The inserts 21 to 26 are formed from electrically conductive aluminum material and, at least partially, part of the ground connection line system 10.

On producing the composite supporting structure 1, the inserts 21 to 26 are inserted, together with the ground connection lines 11 to 13, into the composite material. Here, the inserts 21 to 26 and the ground connection lines 11 to 13 are embedded into the plastic matrix of the composite material and preferably also enclosed by fiber layers.

The inserts 21 to 26 may be partially exposed to improve their accessibility. The ground connection lines 11 to 13 are preferably completely embedded into the composite material of the composite supporting structure 1.

A wiring 30 is arranged outside the composite material of the composite supporting structure L The wiring 30 serves, for example, for the connection of a control device 40. As is indicated by connection lines 31, 32, 33 which connect the control device 40 or the wiring 30 to the inserts 22, 23, 24, the control device 40 and the wiring 30 can be connected to the ground connection line system 10.

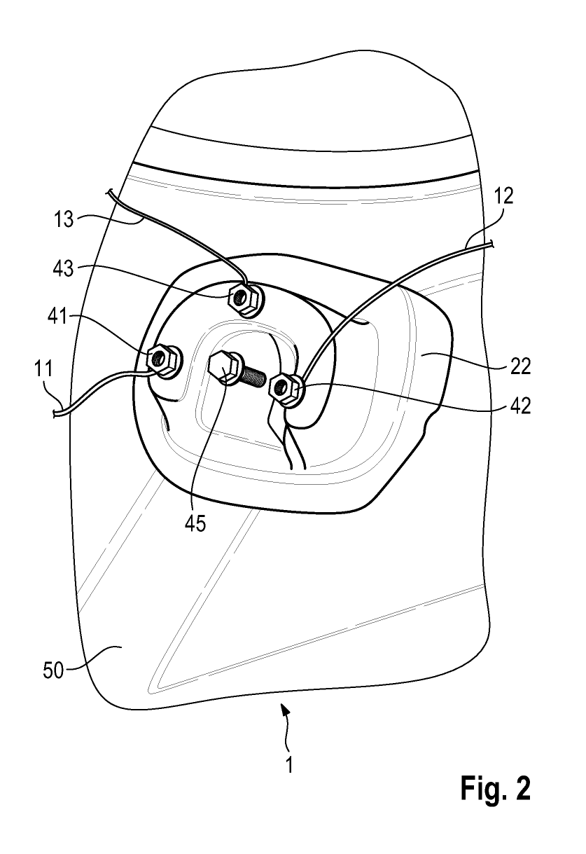

FIG. 2 shows in perspective a. detail from FIG. 1 with an insert 22. The ground connection lines 11 to 13 are connected to the insert 22 in an electrically conducting manner by means of screws 41 to 43.

The ends of the ground connection lines 11 to 13 represented in FIG. 2 are fixedly connected to the insert 22, for example by means of a cured plastic foam, in order to represent an assembled unit.

This assembled unit consisting of the insert 22 and the ground connection lines 11 to 13 can then be fastened by means of a screw 45 to a part-structure 50 of the composite supporting structure 1.

An electrical connection between the ground connection lines 11 to 13 and the insert 22 can then be produced in a simple manner by screwing the screws 41 to 43 into the insert 22 at the corresponding points. To make it easier to find the ground connection line ends, the insert 22 can have markings.

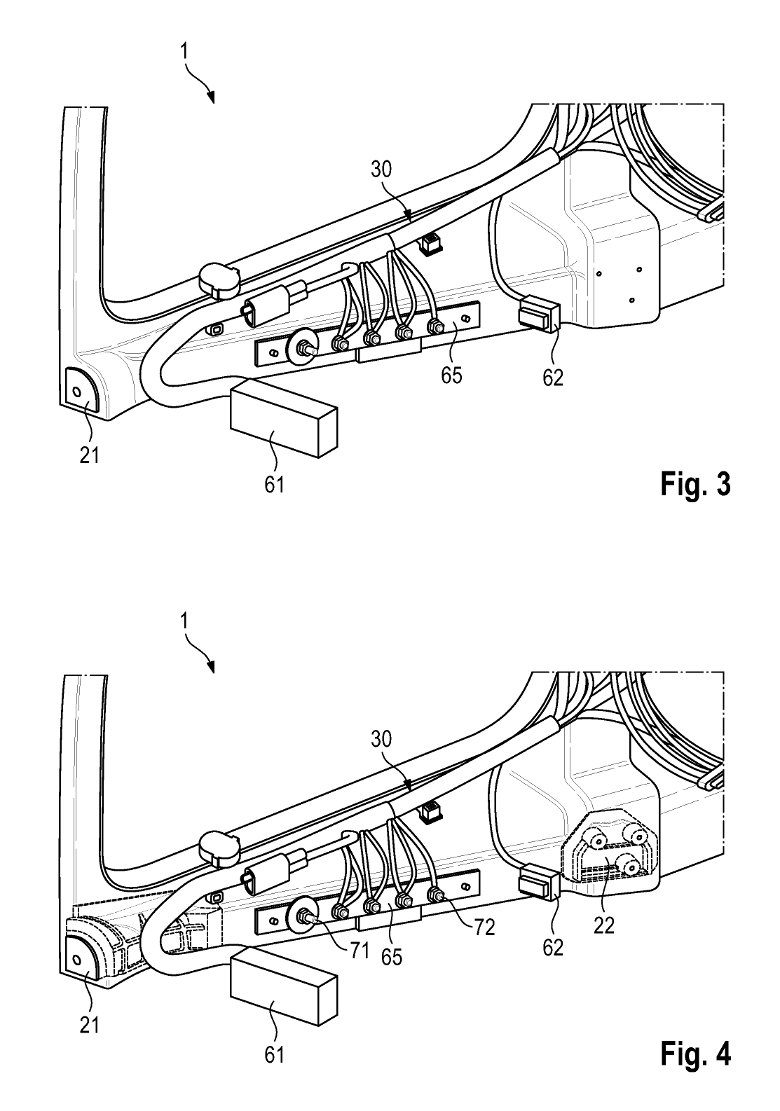

FIGS. 3 and 4 illustrate a further exemplary embodiment of the wiring 30. The wiring 30 comprises two ground plugs 61, 62 in order to connect devices, for example control devices. The wiring 30 is connected via a plurality of connection lines to a ground rail 65. For example, the ground rail 65 can be connected in an electrically conducting manner via screws 71, 72 to a ground connection line which is arranged below the ground rail 65 in the composite material.

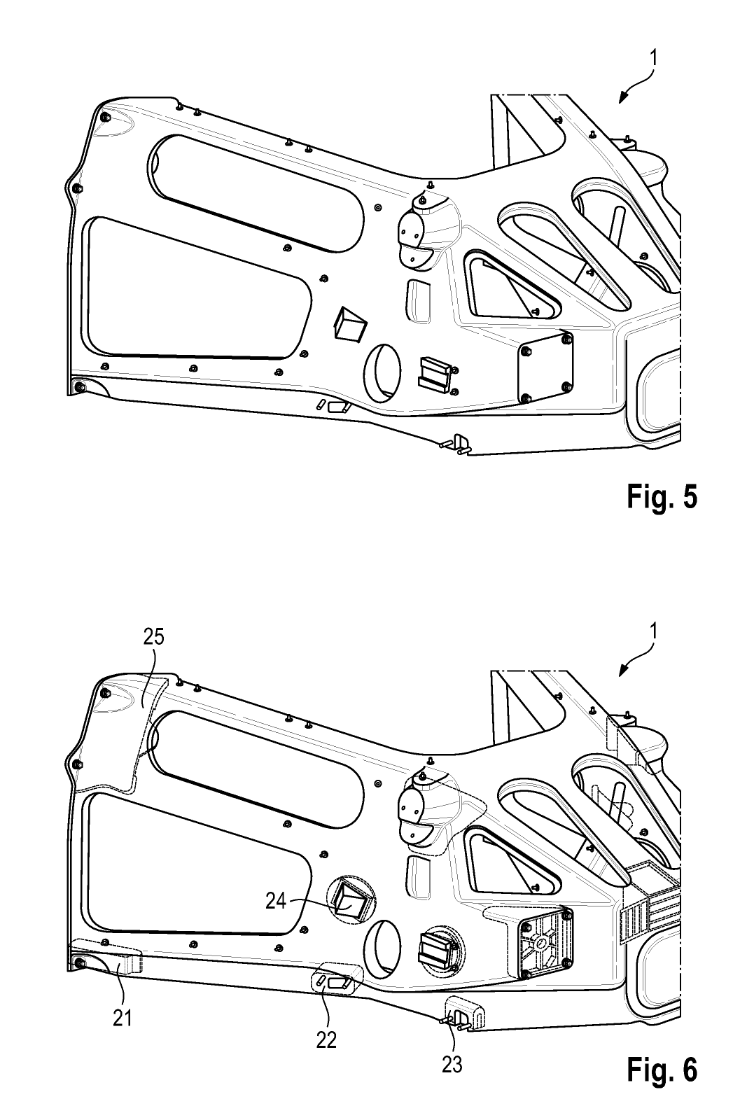

FIGS. 5 and 6 illustrate the composite supporting structure 1 of FIGS. 3 and 4 from outside. It can be seen here that the inserts 22 to 24 are partially visible or accessible from outside. At these outwardly accessible points it is possible, for example, for further functional elements or electrical devices to be connected to the ground connection line system via the inserts 22 to 24.

While the invention has been particularly shown and described with reference to preferred embodiments thereof, it will be understood by those skilled in the art that various changes in form and details may be made therein without departing from the spirit and scope of the invention.

What is claimed is:

1. A vehicle structure comprising:
a composite supporting structure made of a substantially electrically non-conducting composite material; and
at least one ground connection line, the ground connection line being integrated into the composite supporting structure.

2. The vehicle structure recited in claim 1, further comprising two inserts integrated into the composite supporting structure, wherein the at least one ground connection line connects the two inserts in an electrically conducting manner.

3. The vehicle structure recited in claim 2, further comprising additional inserts integrated into the composite supporting structure, and wherein the at least one ground connection line is part of a ground connection line system including a plurality of ground connection lines integrated into the composite supporting structure, each ground connection line connecting two of the inserts in an electrically conducting manner.

4. The vehicle structure recited in claim 1, wherein the at least one ground connection line includes at least one of an electrically conductive fabric or braid.

5. The vehicle structure recited in claim 1, wherein the electrically conductive fabric or braid is aluminum.

6. The vehicle structure recited in claim 2 wherein each insert includes an electrically conductive material.

7. The vehicle structure recited in claim 6, wherein the electrically conductive material is aluminum.

8. The vehicle structure recited in claim 2, wherein the inserts are inserted or embedded into the composite supporting structure with the at least one ground connection line.

9. The vehicle structure recited in claim 2, wherein the inserts are connected to the at least one ground connection line for assembly or manufacturing purposes.

10. The vehicle structure recited in claim 1, wherein the at least one ground connection line is enclosed by at least one fiber layer of an electrically insulating fiber material of the composite supporting structure.

11. The vehicle structure recited in claim 2, wherein the inserts are enclosed by at least one fiber layer of an electrically insulating fiber material of the composite supporting structure.

12. The vehicle structure recited in claim 1, further comprising a ground rail connected to the at least one ground connection line by a fastening element including an electrically conductive material.

13. The vehicle structure recited in claim 2, wherein the inserts are connected to the at least one ground connection line by fastening elements including an electrically conductive material.

14. At least two inserts and at least one ground connection line for a composite supporting structure made of an electrically non-conducting or non-sufficiently conducting composite material, the at least one ground connection line being configured to connect the at least two inserts in an electrically conductive manner and to be embedded in the composite supporting structure.

15. A motor vehicle comprising:
a composite supporting structure made of a substantially electrically non-conducting composite material; and
at least one ground connection line, the ground connection line being integrated into the composite supporting structure.
